(19) United States
(12) Patent Application Publication
(10) Pub. No.: US 2004/0063485 A1
(43) Pub. Date: Apr. 1, 2004

(54) Bet registration system

(76) Inventor: Derek J. Webb, Derby (GB)

Correspondence Address: NIXON & VANDERHYE P.C., 8th Floor, 1100 North Glebe Rd., Arlington, VA, 22201-4714, US

(21) Appl. No.: 10/259,437

(22) Filed: Sep. 30, 2002

(51) Int. Cl. A63F 13/00

(52) U.S. Cl. 463/16

(57) ABSTRACT

A bet registration apparatus registers and displays multiple player wagers in a game of chance. The bet registration apparatus includes a player section visible to the game players, including a first player position indicator and a first wager indicator for each respective player position. A dealer section is visible to the dealer and includes a second player position indicator, a second wager indicator, and at least one bet registration button for each respective player position. A processor is operatively coupled with the at least one bet registration button for each respective player position. The processor includes a memory circuit that registers the player wagers according to operation of the at least one bet registration button. In one embodiment, the first and second player position indicators are encompassed by a single unit.

### CROSS-REFERENCES TO RELATED APPLICATIONS

(NOT APPLICABLE)

### STATEMENT REGARDING FEDERALLY SPONSORED RESEARCH OR DEVELOPMENT

(NOT APPLICABLE)

### BACKGROUND OF THE INVENTION

The present invention relates to casino game accessories and, more particularly, to an apparatus and method for registering wagers in a casino table game.

A mechanical/electronic method of recording bets has been in use, for example in Caribbean Stud, which is generally described in U.S. Pat. No. 4,861,041 and others. This game features a progressive jackpot whereby each dollar wagered on the jackpot is placed in a designated slot for each player. The wager is recorded and a percentage of the dollar (e.g., 50%) is accrued towards the progressive jackpot meter amount. The dollars or dollar chips fall through the mechanism and are collected from a deposit tray by the dealer and placed in the dealer chip tray.

The table game Let-it-Ride Bonus Bet, generally described in U.S. Pat. No. 5,288,081, features a high-odds payoff for a dollar wager of typically up to $20,000 for a Royal Flush. Each player area has a circle with a sensor that illuminates when a chip is placed on it and that effects recording of the wager. Dollars wagered on the Bonus Bet are scooped into the chip tray by the dealer. Whilst there is no requirement to record the placement of the dollar for jackpot accrual as with Caribbean Stud, there are two benefits for the casino operator.

Firstly, the illuminated sensor provides both the player and the casino with a secure record of the placement of the wager after the wager has been removed from the table. This acts as a game protection measure to prevent a late bet being placed on a hand that had already been seen by the player. Secondly, by using a program to record the wagers placed, there is an accurate assessment of the number of Bonus Bets placed. This provides the casino operator with an analysis of the participation in the bet and, after deducting payoffs, an amount retained by the casino on the bet.

Other Blackjack sidebet games have used similar concepts. Madness 21 or Wheel of Madness can be operated with the sensor system. Some casino operators believe the illumination encourages participation in the side bet during the game. Bonus Blackjack uses a button pad to record wagers placed on a side bet, with each wager resulting in an increase on the metered payoff. The number of wagers in the side bet is recorded but the wagers remain on the table until after resolution of the bets.

Both of the methods associated with Caribbean Stud and Let-it-Ride require dedicated physical equipment set into the table. The equipment used with Bonus Blackjack has the advantage that it can be just set onto the existing table top. However, the Bonus Blackjack equipment does not cater for bet removal prior to bet resolution. None of the existing methods allow for variable wager recording.

### BRIEF SUMMARY OF THE INVENTION

The invention is of a new apparatus and method of bet registration. There are a number of new and advantageous features which will be apparent in the disclosure. The equipment generally comprises a dedicated unit which can be conveniently placed on an existing table top. The unit has preferably an individual button area for each individual player and preferably one or more illuminated display areas visible to both the players and the dealer. The unit is readily configurable to work with technology in use for existing games such as Caribbean Stud, Let-it-Ride, and the like.

Each player bet area around the table is given a number of for example 1 through 7 for a seven player game, in a standard rotation. The unit incorporates the same numbers in the same sequence. For each number, there is a button area and at least one and preferably two display areas, being one angled towards the players and one towards the dealer. Each player has a dedicated bet area specifically for the side bet for the game being played.

Side bets are common in house-banked table games and particularly so in Blackjack and Poker. For example, in addition to the games Caribbean Stud and Let-it-Ride as already described, Pai Gow Poker offers a variety of side bet options. For example, in Fortune Pai Gow, the player may bet for example from $1 to $5 or from $1 to $25 depending on the limits operated by the casino.

At Three Card Poker, generally described in U.S. Pat. No. 5,685,774, by the same author, the game can be operated whereby the Pair Plus proposition is played as a side bet. This method was also used in the game Tre Card Stud, which incorporated an electronic progressive jackpot as a substitute for the Pair Plus. Tre Card Stud failed on the casino floor as players could not bet more than the fixed amount of the progressive wager, either $1 or $5 for example, and also could not vary the amount of the bet. Having less player appeal, the game was naturally less viable to casino operators than Three Card Poker.

The system of the invention allows the dealer to input the amount of the wager, so allowing for variable side bets. Further, the recording facility stores the wager amounts and the registration shows the amounts wagered to both players and dealer through the one or more illuminated displays.

In an exemplary embodiment of the invention, a bet registration apparatus is provided for registering and displaying multiple player wagers in a game of chance. The bet registration apparatus comprises a player section visible to the game players including a first player position indicator and a first wager indicator for each respective player position. A dealer section visible to the dealer includes a second player position indicator, a second wager indicator, and at least one bet registration button for each respective player position. A processor having a memory circuit registers the player wagers according to operation of the at least one bet registration button.

The first and second wager indicators are preferably illuminated displays. The at least one bet registration button may be configured to register wagers of varying values, either including a separate registration button for each possible wager value, or being depressable multiple times corresponding to each possible wager value. The first and second wager indicators preferably include multiple display sections for each respective player position, thereby enabling separate registration of multiple wagers for each player.

A method of playing a game of chance including a side wager uses the bet registration apparatus of the present invention. The method includes the steps of (a) receiving a player wager for the game of chance; (b) receiving at least one side wager; and (c) displaying and registering the at least one side wager with the bet registration apparatus. In this context, the game of chance may be a card game utilizing playing cards dealt from a dealer to the player, wherein the method further includes removing the at least one side wager either prior to or after dealing cards to the player.

The bet registration apparatus may be operatively coupled with a progressive jackpot system accruing a progressive jackpot, wherein the registered wagers are communicated to the progressive jackpot system. In this context, either a predetermined percentage or a fixed amount of the registered wagers may be accrued to the progressive jackpot. A plurality of progressive jackpots may be accrued, each having a different wager level, wherein each side wager is separately displayed for each of the plurality of progressive jackpots. In one operating mode, the player is only permitted to wager on one of the plurality of progressive jackpots. The registration step may be practiced by detecting an amount of the at least one side wager, apportioning the at least one side wager to each of the plurality of progressive jackpots, and automatically displaying and registering the at least one side wager with the bet registration apparatus.

In another operating mode, the game of chance is a card game utilizing playing cards dealt from a dealer to the player, the dealer dealing multiple hands to the player, wherein the method further includes accruing independent progressive jackpots, one for each of the multiple hands. In this context, the registration step may be practiced by detecting an amount of the at least one side wager, apportioning the at least one side wager to each of the independent progressive jackpots, and automatically displaying and registering the at least one side wager with the bet registration apparatus.

In still another arrangement, the first player position indicator and the second player position indicator comprise a single unit visible to both the game players and the dealer, and the first wager indicator and the second wager indicator comprise a single unit visible to both the game players and the dealer.

In another exemplary embodiment of the invention, a method of registering and displaying multiple player wagers in a game of chance includes the steps of (a) receiving at least one wager from a player; (b) displaying the at least one wager in a player section visible to the game players, the player section including a first player position indicator and a first wager indicator for each respective player position; (c) displaying the at least one wager in a dealer section visible to the dealer, the dealer section including a second player position indicator, a second wager indicator, and at least one bet registration button for each respective player position; and (d) registering the player wagers according to operation of the at least one bet registration button.

In still another exemplary embodiment of the invention, a bet registration apparatus includes a player position indicator, a wager indicator for each respective player position, at least one bet registration button for each respective player position, and a processor operatively coupled with the at least one bet registration button for each respective player position. The processor includes a memory circuit that registers the player wagers according to operation of the at least one bet registration button.

### BRIEF DESCRIPTION OF THE DRAWINGS

These and other aspects and advantages of the present invention will be described in detail with reference to the accompanying drawings, in which:

FIG. 1 is a side view of the bet registration apparatus of the present invention;

FIG. 2 is an exemplary front view from the players' perspective; and

FIG. 3 is an exemplary plan view from the dealer's perspective.

### DETAILED DESCRIPTION OF PREFERRED EMBODIMENTS

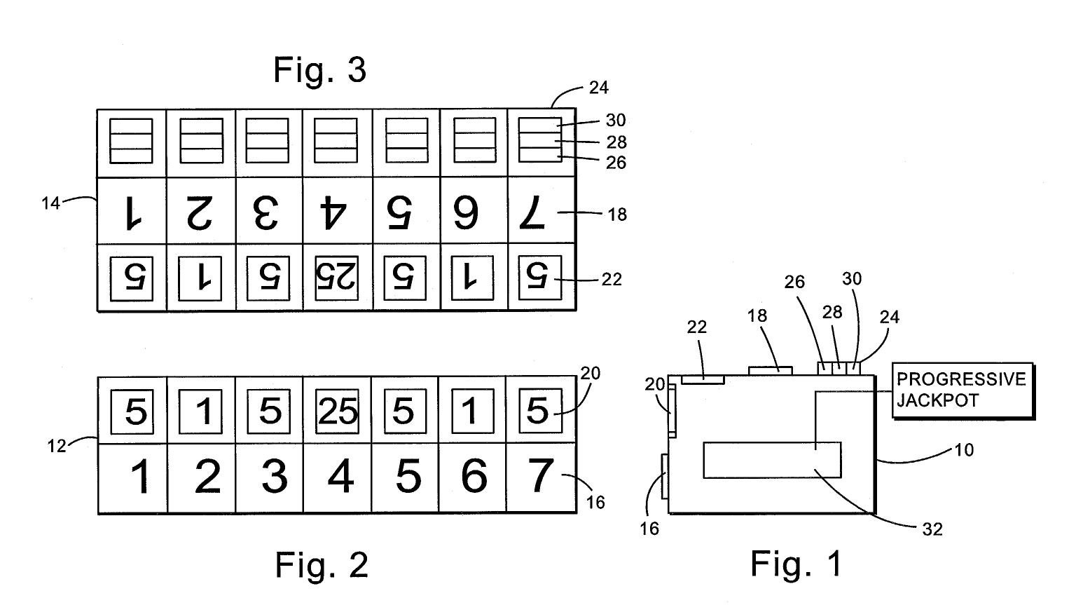

With reference to FIGS. 1-3, the bet registration system according to the present invention includes a housing 10 having a player section 12 and a dealer section 14. The system incorporates a fixed numerical display of player positions 16 on the player section 12 and an identical numerical display of player positions 18 in the dealer section 14. The system also incorporates an illuminated display of bet registration 20 in the player section 12 and an identical illuminated display of bet registration 22 in the dealer section 14. Each illuminated display of bet registration 20, 22 relates directly to each appropriate numerical display of player position 16, 18.

The system includes a button area 24 with each button area 24 relating to each appropriate numerical display of player position 16, 18 and each appropriate illuminated display of bet registration 20, 22. In one preferred embodiment of the invention, each button area 24 includes three different buttons 26, 28 and 30. Each of the three buttons 26, 28 and 30 relates to a different wager amount resulting in different bet registration amounts being displayed in the illuminated areas 20, 22. The system also incorporates a processor 32 including a memory circuit to record all bets registered. The logic software preferably transmits the recorded bets to a progressive jackpot meter (not shown).

Each player wishing to play the wager places a bet in the appropriate bet area on the table layout. The layout is optionally marked with numbers in sequence relating to player positions around the table. Typically, the table may accommodate up to seven players, so a sequence of 1 through 7 inclusive in order of rotation would apply. After all bets are placed, the dealer uses the registration buttons 24 to register and record the bets.

For example, as shown in the drawings, the players in seats 2 and 6 have each placed a $1 bet, whereas the players in seats 1, 3, 5 and 7 have each placed $5 bets, and the player in seat 4 has placed a $25 bet. The dealer pressed button 24 to register the $1 bets at 20 and 22 for players 2 and 6, pressed button 26 to register the $5 bets at 20 and 22 for players 1, 3, 5 and 7 and pressed button 28 to register the $25 bet at 20 and 22 for player 4. All bets are recorded via the processor 32 as the buttons at 24 are pressed. The dealer may collect the bets prior to proceeding with the play of the game, relying solely on bet registration as bet verification, or may deal the game and resolve all bets in standard rotation.

In another embodiment, a player may play in more than one jackpot so that more than one of the three buttons 26, 28 and 30 could be pressed at the same time, resulting in additional wager totals of $6, $26, $30 or $31. However, a preferably illuminated display would show each of wagers placed, rather than the total.

In another embodiment, one button only could be available in each button area 24. In this case, the button would be pressed once only to register the lowest wager amount and twice to register the next lowest wager amount and so on. Alternatively, in another embodiment with one button in each button area 24, a fixed wager could be registered in the illuminated display 20, 22 as say $1 or “YES.”

As noted, the system could be utilized with the method of removing the side bet wagers prior to delivery of the player hands, or alternatively could be utilized with the side bet wagers retained on the table. Additionally, the system could be used with a standard progressive jackpot, with a percentage of each fixed wager accrued to the jackpot. Alternatively, the system could be used with a progressive jackpot such as applied to Bonus Blackjack whereby each wager accrues a fixed amount to the progressive jackpot meter total irrespective of the amount of the wager.

As a further alternative, the system could be operated with two or more simultaneous progressive jackpots. Each jackpot would have a different wager level attributable to that particular jackpot. For example, a game could have both a $1 wager jackpot and a $5 wager jackpot. The player could be allowed to play either jackpot or both jackpots at a total wager of $6 for both jackpots.

Generally, the method of operation of the two described jackpots would be to seed the $5 jackpot with an initial seed amount of five times the seed amount of the $1 jackpot. Each jackpot would grow according to wagers placed. For example, the premium hand to win a jackpot, such as a Royal Flush in a five-card house-banked Poker game, may only have a wager in one of the two jackpots at a time. This would mean that although that particular jackpot would be won and reseeded, the other jackpot would continue regardless at the current jackpot meter amount.

This method of simultaneous jackpots removes one of the primary problems associated with the current progressive jackpots. After the jackpot has been won and reseeded, the amount on the meter is relatively low. There is therefore a lower participation in the jackpot than when the meter is high and less attraction for a player to play the game. As the jackpot increases, jackpot participation increases and more players are attracted to the game. With two or more different jackpots, there may usually be at least one of them at a sufficiently high level to generate a good level of participation.

Typically, a game with a progressive jackpot in a small casino is only a marginal asset at best. When the jackpot is low, the level of play often does not justify operator retention of the game. However, once the jackpot is live, the game cannot be removed from the casino floor until the jackpot has been won. When the jackpot becomes high, the increased play appears to justify operator retention. The casino operator is faced with the difficult decision of whether to remove the game immediately after the jackpot is won. This could give a message to players that the casino does not like to pay a big winner.

The system additionally enables multiple jackpots. For example, a $25 jackpot could be operated in addition to a $1 and $5 jackpot. To ensure that all jackpots are not won at once, the game could be operated whereby the player can only participate in one of the three jackpots, ensuring that there would always be an attractive jackpot amount and adequate game participation.

Those with skill in the art will realize that use of the invention could apply to many casino table games, in particular games incorporating side bets and in particular popular games such as Blackjack and house-banked poker games such as Pai Gow Poker and Three Card Poker. Additionally, although a preferred embodiment describes distinct player and dealer sections, the system may combine them into only a single section visible to both the game players and the dealer.

The invention could also apply to these above games and other games in an internet gaming format. In this instance, software would replace the equipment and would record and register bets in an on-screen application.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A bet registration apparatus for registering and displaying multiple player wagers in a game of chance, the bet registration apparatus comprising:
a player section visible to the game players, the player section including a first player position indicator and a first wager indicator for each respective player position;
a dealer section visible to the dealer, the dealer section including a second player position indicator, a second wager indicator, and at least one bet registration button for each respective player position; and
a processor operatively coupled with the at least one bet registration button for each respective player position, the processor including a memory circuit that registers the player wagers according to operation of the at least one bet registration button.

2. A bet registration apparatus according to claim 1, wherein the first and second wager indicators are illuminated displays.

3. A bet registration apparatus according to claim 1, wherein the at least one bet registration button is configured to register wagers of varying values.

4. A bet registration apparatus according to claim 3, comprising a separate registration button for each possible wager value.

5. A bet registration apparatus according to claim 3, comprising a single bet registration button for each respective player position, the single bet registration button being depressable multiple times corresponding to each possible wager value.

6. A bet registration apparatus according to claim 1, wherein the first and second wager indicators include multiple display sections for each respective player position, thereby enabling separate registration of multiple wagers for each player.

7. A method of playing a game of chance including a side wager using the bet registration apparatus of claim 1, the method comprising:
(a) receiving a player wager for the game of chance;
(b) receiving at least one side wager; and
(c) displaying and registering the at least one side wager with the bet registration apparatus.

8. A method according to claim 7, wherein the game of chance is a card game utilizing playing cards dealt from a dealer to the player, the method further comprising removing the at least one side wager prior to dealing cards to the player.

9. A method according to claim 7, wherein the game of chance is a card game utilizing playing cards dealt from a dealer to the player, the method further comprising removing the at least one side wager after dealing cards to the player.

10. A method according to claim 7, wherein the bet registration apparatus is operatively coupled with a progressive jackpot system accruing a progressive jackpot, the method further comprising communicating the registered wagers to the progressive jackpot system.

11. A method according to claim 10, further comprising accruing a predetermined percentage of the registered wagers to the progressive jackpot.

12. A method according to claim 10, further comprising accruing a fixed amount of the registered wagers to the progressive jackpot, irrespective of the wager amount.

13. A method according to claim 10, further comprising accruing a plurality of progressive jackpots, each having a different wager level.

14. A method according to claim 13, wherein step (c) is practiced by separately displaying each side wager for each of the plurality of progressive jackpots.

15. A method according to claim 13, wherein the player is only permitted to wager on one of the plurality of progressive jackpots.

16. A method according to claim 13, wherein step (c) is practiced by detecting an amount of the at least one side wager, apportioning the at least one side wager to each of the plurality of progressive jackpots, and automatically displaying and registering the at least one side wager with the bet registration apparatus.

17. A method according to claim 10, wherein the game of chance is a card game utilizing playing cards dealt from a dealer to the player, the dealer dealing multiple hands to the player, wherein the method further comprises accruing independent progressive jackpots, one for each of the multiple hands.

18. A method according to claim 17, wherein step (c) is practiced by detecting an amount of the at least one side wager, apportioning the at least one side wager to each of the independent progressive jackpots, and automatically displaying and registering the at least one side wager with the bet registration apparatus.

19. A method according to claim 7, wherein the game of chance is a card game utilizing playing cards dealt from a dealer to the player, the method further comprising registering the at least one side wager prior to dealing cards to the player.

20. A method according to claim 7, wherein step (c) is practiced by detecting an amount of the at least one side wager, and automatically displaying and registering the at least one side wager with the bet registration apparatus.

21. A bet registration apparatus according to claim 1, wherein the first player position indicator and the second player position indicator comprise a single unit visible to both the game players and the dealer, and wherein the first wager indicator and the second wager indicator comprise a single unit visible to both the game players and the dealer.

22. A method of playing a game of chance using a bet registration apparatus for registering and displaying multiple player wagers, the method comprising:
(a) receiving a player wager for the game of chance;
(b) receiving at least one side wager; and
(c) displaying and registering the at least one side wager with the bet registration apparatus.

23. A method according to claim 22, wherein the game of chance is a card game utilizing playing cards dealt from a dealer to the player, the method further comprising removing the at least one side wager prior to dealing cards to the player.

24. A method according to claim 22, wherein the game of chance is a card game utilizing playing cards dealt from a dealer to the player, the method further comprising removing the at least one side wager after dealing cards to the player.

25. A method according to claim 22, wherein the bet registration apparatus is operatively coupled with a progressive jackpot system accruing a progressive jackpot, the method further comprising communicating the registered wagers to the progressive jackpot system.

26. A method according to claim 25, further comprising accruing a predetermined percentage of the registered wagers to the progressive jackpot.

27. A method according to claim 25, further comprising accruing a fixed amount of the registered wagers to the progressive jackpot, irrespective of the wager amount.

28. A method according to claim 25, further comprising accruing a plurality of progressive jackpots, each having a different wager level.

29. A method according to claim 28, wherein step (c) is practiced by separately displaying each side wager for each of the plurality of progressive jackpots.

30. A method according to claim 28, wherein the player is only permitted to wager on one of the plurality of progressive jackpots.

31. A method according to claim 28, wherein step (c) is practiced by detecting an amount of the at least one side wager, apportioning the at least one side wager to each of the plurality of progressive jackpots, and automatically displaying and registering the at least one side wager with the bet registration apparatus.

32. A method according to claim 25, wherein the game of chance is a card game utilizing playing cards dealt from a dealer to the player, the dealer dealing multiple hands to the player, wherein the method further comprises accruing independent progressive jackpots, one for each of the multiple hands.

33. A method according to claim 32, wherein step (c) is practiced by detecting an amount of the at least one side wager, apportioning the at least one side wager to each of the independent progressive jackpots, and automatically displaying and registering the at least one side wager with the bet registration apparatus.

34. A method according to claim 22, wherein the game of chance is a card game utilizing playing cards dealt from a dealer to the player, the method further comprising registering the at least one side wager prior to dealing cards to the player.

35. A method according to claim 22, wherein step (c) is practiced by detecting an amount of the at least one side wager, and automatically displaying and registering the at least one side wager with the bet registration apparatus.

36. A method of registering and displaying multiple player wagers in a game of chance, the method comprising:
(a) receiving at least one wager from a player;
(b) displaying the at least one wager in a player section visible to the game players, the player section including a first player position indicator and a first wager indicator for each respective player position;
(c) displaying the at least one wager in a dealer section visible to the dealer, the dealer section including a second player position indicator, a second wager indicator, and at least one bet registration button for each respective player position; and
(d) registering the player wagers according to operation of the at least one bet registration button.

37. A bet registration apparatus for registering and displaying multiple player wagers in a game of chance, the bet registration apparatus comprising:
a player position indicator;
a wager indicator for each respective player position;
at least one bet registration button for each respective player position; and
a processor operatively coupled with the at least one bet registration button for each respective player position, the processor including a memory circuit that registers the player wagers according to operation of the at least one bet registration button.
